(19) United States
(12) Patent Application Publication
(10) Pub. No.: US 2014/0134705 A1
(43) Pub. Date: May 15, 2014

(54) OIL SPILL CONTAINMENT SYSTEM AND METHOD

(71) Applicant: James Jackson Milham Henry, Houston, TX (US)

(72) Inventor: James Jackson Milham Henry, Houston, TX (US)

(73) Assignee: ROK INVESTMENT GROUP LIMITED, Albrighton, West Midlands (UK)

(21) Appl. No.: 14/128,619

(22) PCT Filed: Jun. 25, 2012
(86) PCT No.: PCT/US12/44057

§ 371 Date: Dec. 22, 2013

Related U.S. Application Data
(60) Provisional application No. 61/500,537, filed on Jun. 23, 2011.

(51) Int. Cl. A62D 3/02

(52) U.S. Cl. CPC A62D 3/02
USPC 435/253.6; 210/502.1; 210/610; 435/262.5

(57) ABSTRACT

The present invention is directed to environmental remediation, and specifically to materials, systems, and methods for oil spill clean up. A system for oil spill containment incorporates an oil adsorbing material and bacterial nutrient material. The oil adsorbing material may be a polymeric material. The polymeric material may be one or more of a synthetic polymer and a natural product. Suitable synthetic polymers include polypropylene, polyethylene, polyurethane, polyester, and combinations thereof. The synthetic polymer may be recycled. Suitable natural produces include palm oil and beeswax. The bacterial nutrient may be organic or inorganic. A suitable organic bacterial nutrient is bee pollen. Suitable inorganic bacterial nutrients include nitrates and phosphates. A method for containing oil in an oil spill at a location incorporates applying the oil spill containment system to the oil and removing the oil and the oil spill containment system from the location. The system and method have the advantage of both short term adsorption of oil by the oil adsorbing particles and long term degradation of the oil by bacteria fed by the bacterial nutrient material.

### CROSS-REFERENCE TO RELATED APPLICATIONS

This Application for Patent claims priority to U.S. Provisional Patent Application Ser. No. 61/500537, filed Jun. 23, 2011.

### FIELD OF THE INVENTION

The present invention relates generally to environmental remediation, and specifically to materials, systems, and methods for oil spill clean up.

### BACKGROUND OF THE INVENTION

The long term effects of large oil spills, as observed over the last 100 years, can include environmental impact. However, the history of oil spill containment technologies is of relatively recent advent.

It is known that petroleum/hydrocarbon based liquids when they spill, can come in contact with the ground and leach, pour or leak into streams and rivers leading to serious environmental damage. This environmental damage is especially true if a train derails. Trains have 1200 to 1600 gallon belly tanks full of diesel fuel, that are unprotected and only a few inches is the clearance to the rail and the ground. They routinely rupture immediately upon the train coming off the rails. Derailments are a relatively common occurrence, according to Federal Rail Safety Administration, about 2000 per year. However, most of them occurred at speeds under 5 miles an hour and in the rail yard itself. This type of oil spill needs remediated, that is cleaned up, immediately to avoid serious environmental damage to rivers, lakes, and streams.

At first glance, wisdom would dictate that oil spills and more especially, major quantities of oil being pumped into the clean waters of an ocean, estuary, bay or river not to mention oil spills on land, would be considered a catastrophe of monumental proportions. Hundreds of oil tankers sunk off the east coast during the war years from 1941 through 1945. Over the many months and years, these oil spills were re-mediated by naturally occurring bacteria. According to EPA studies and the National Risk Management Research Laboratory and their Office of Research and Development research continues, in terms of cataloging and studying long term damage to ocean flora and fauna culminating from large releases of petroleum fluids into the ocean and inland waters.

We have an option now to significantly enhanced and safely remediate oil spills.

Officially speaking “The EPA is charged by congress with protecting the nation's land, air and water resources”. per Lawrence W. Reiter Acting Director of the National Risk Management Research Laboratory.

In the report by his agency dated July 2004 [EPA/600/R-04/075] a comprehensive study was done regarding the effectiveness of bioremediation agents for cleanup of oil-contaminated estuarine environments.

The study found that “inorganic nutrients” were considered much more effective at bio-remediation than bio-augmentation and more especially the fact that “inorganic nutrients” enhanced bio-degradation in an extremely effective manner as reported by EPA sanctioned studies.

This means that in numerous scientific studies, dated all the way back to 1997, it was found that the most effective compounds to enhance biodegradation were essentially made up of materials such as, but not limited to, nitrates and phosphates.

These compounds actively “feed” naturally occurring oil eating bacteria. such as but not limited, flavobacterium, sp- cytophoga, sp- pseudomonas, sp xanthomonas, sp alcaligenes, sp arthrobacter, sp.

By feeding the bacterium that are naturally occurring native organisms already present in the environment, the oil degradation is accelerated to a considerable degree.

Accordingly, citing testing from EPA reports as listed above, the introduction of only the “inorganic nutrients” accelerated oil degradation by factors of 10 to 25 times over doing nothing [10 times better] and [25 times better] than the addition of commercial organic bio-augmentation and bio-remediation compounds currently on the market.

The problem that exists with these “feed stocks” as a stand alone solution, is that they work very, very slowly over several months up to six months and longer in some case.

### BRIEF DESCRIPTION OF THE INVENTION

The present invention is directed to environmental remediation, and specifically to materials, systems, and methods for oil spill clean up. A system for oil spill containment incorporates an oil adsorbing material and bacterial nutrient material. The oil adsorbing material may be a polymeric material. The polymeric material may be one or more of a synthetic polymer and a natural product. Suitable synthetic polymers include polypropylene, polyethylene, polyurethane, polyester, and combinations thereof. The synthetic polymer may be recycled. Suitable natural produces include palm oil and beeswax. The bacterial nutrient may be organic or inorganic. A suitable organic bacterial nutrient is bee pollen. Suitable inorganic bacterial nutrients include nitrates and phosphates. A method for containing oil in an oil spill at a location incorporates applying the oil spill containment system to the oil and removing the oil and the oil spill containment system from the location. The materials, system and method have the advantage of both short term adsorption of oil by the oil adsorbing particles and long term degradation of the oil by bacteria fed by the bacterial nutrient material.

According to some embodiments, an oil spill containment system incorporates a plurality of granules of a bacterial nutrient material; and a plurality of particles of a polymeric material active for adsorbing oil.

The polymeric material may comprise a synthetic polymer. Alternately, or in combination, the polymeric material may comprise a natural product. The synthetic polymer may be selected from the group consisting of polypropylene, polyethylene, polyurethane, polyester, and combinations thereof. The synthetic polymer may comprises recycled polymer. The natural product may be selected from the group consisting of palm oil, beeswax. The natural product may comprise coconut flakes.

The bacterial nutrient material may comprise an inorganic compound selected from the group consisting of nitrates and phosphates. The bacterial nutrient material may comprise bee pollen. The bacteria may be naturally occurring bacteria such as but not limited to flavobacterium, sp- cytophoga, sp- pseudomonas, sp xanthomonas, sp alcaligenes, sp arthrobacter, sp.

According to some embodiments, a method for containing an oil spill at a location comprises mixing a plurality of particles of a polymeric material active for adsorbing oil with a plurality of granules of a bacterial nutrient material so as to form an oil spill containment system, applying the oil spill containment system to the oil; and removing the oil and the oil spill containment system from the location. The method may further comprise allowing the oil to adsorb to the particles of the polymeric material before the removing. The method may further comprise exposing the oil and the oil spill containment system to bacteria after the removing. The exposing may comprise allowing the bacteria to break down the oil, fed by the bacterial nutrient material.

The foregoing has outlined rather broadly the features of the present invention in order that the detailed description of the invention that follows may be better understood. Additional features and advantages of the invention will be described hereinafter which form the subject of the claims of the invention.

### DETAILED DESCRIPTION OF THE INVENTION

The present invention is directed to materials, systems, and methods adapting for achieving both short and long term remediation. An oil adsorbing material provides the short term remediation. The oil adsorbing material acts by adsorbing and coagulating the oil. A bacterial nutrient material provides the long term remediation. The bacterial nutrient material acts by being a feed stock for available bacteria that degrade the oil. The bacteria may be naturally occurring bacteria such as but not limited to flavobacterium, sp- cytophoga, sp- pseudomonas, sp xanthomonas, sp alcaligenes, sp arthrobacter, sp.

By recognizing this fact the inventor also has application experience with polymers that quickly absorb and coagulate petroleum/hydrocarbon based liquids.

The combinations of these multiple compounds constitute the development of the art as described more fully below.

The present invention provides a new product technology whereby the combining of proven compounds such as, but not limited to, certain types of granular shaped nitrates combined with certain granular shaped phosphates could be combined with polymers such as, but not limited to, polypropylene, polyethylene, polyurethane, polyesters, polystyrene, palm oils, and plant derived natural particles such as but not limited to, beeswax as a natural oil adsorbent.

The combination of proven oil adsorbing polymers such as but not limited to, polypropylene as one of many examples, and the others listed in various combinations mixed with “inorganic nutrients” that degrade oil and or hydrocarbon based liquids, would provide a unique formula to accomplish two purposes at once as it relates to oil spill remediation.

The performance factors of HYDRO-TAIN will be demonstrated by application of the product on ground based oil spills as well as water applications.

The polymers will adsorb and contain the oil within a few minutes, and the “inorganic nutrients” will provide a feed stock for the indigenous bacterium to begin the process of bio-degradation.

Other compounds for oil spill remediation fall into the category of either consisting of bio-augmentation compounds (e.g. made by companies like BioEnviro Tech, Verde Environmental Products, Oppenheimer Biotechnology, etc.) or Bio-Remediation compounds, such as but not limited to: enzyme additive compounds for example, Oil Spill Eater International.

According to some embodiments, HYDRO-TAIN is a functionally unique combination of phosphate and/or nitrates with oil coagulating polymers, different from firms that sell just polymer adsorbent additives such as, but not limited to, Sorbican, Supertex-inc, Adsorbents Online, MPC Containment, AB Tech Industries. According to some embodiments, ROK Solid X Factor contains recycled polymer and coconut flakes. According to some embodiments, ROK Solid X Factor has a composition of 95% recycled polymer and 5% coconut flakes.

The present invention provides for unique combinations of oil coagulating polymers, combined with naturally occurring plant based oils, such as but not limited to, palm oils, as well as oil eating “inorganic nutrients” constitute a unique product that accomplishes two functions in one product, with the ability to quickly remove oil from the environment, and then begin the slower but environmentally critical function of breaking the oil down into carbon-dioxide and fatty acids. Thus cleaning and effectively removing the oil spill from the environment.

It will be understood, that while embodiments of the present invention have been described as a combination of polymeric oil adsorbing material and bacterial nutrient material, embodiments of oil containment material including the polymeric oil adsorbing material and excluding the bacterial nutrient material are contemplated.

The following examples are provided to more fully illustrate some of the embodiments of the present invention. It should be appreciated by those of skill in the art that the techniques disclosed in the examples which follow represent techniques discovered by the inventors to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

### EXAMPLES

These examples are illustrated online at http://www.youtube.com/playlist?list=PLA119B62544FE85E9, items 6 (water, Examples 1 and 2) and 5 (dry land, Example 3).

### Example 1

This Example serves to illustrate the oil containment action of the polymeric oil adsorbing material for an oil spill on water.

In a typical procedure, an emulsion of 50/50 oil and light crude directly out of the Gulf was blended for about five minutes. The emulsion, also termed in this example fuel, was applied to water contained in an inflatable wading pool. The water was a 6.3% saline solution. The emulsion was observed to spread out in a layer over the water. A polymeric oil spill containment material, ROK HCA-10, available from ROK Protective Systems, Inc., was applied to the emulsion layer. As soon as the material hit the emulsion, the material and emulsion separated together so as to form a coagulate. About one pound of ROK HCA-10 was applied to five pounds of fuel. The polymeric containment material is non-sticky. It does not stick to a net or one's hands, and there is no film on the net or hands. Further, there is no oil smell. After not more than an hour, it was ready to clean up. A hose of water was used to push the coagulate on the surface of the water. The water was exemplary of mechanical force to heard the coagulate. The coagulate was collected at a side of the pool. It was lifted from the pool with a stiff sheet. The coagulate clumped easily into a continuous mass when handled. When the coagulate is dried, the fuel can be re-burned for energy.

### Example 2

This Example serves to illustrate further the oil containment action of the polymeric material for an oil spill on water.

In a typical procedure, 25% crude/75% sea water was added to water in a pool, the water and pool as in Example 1. The polymeric containment material, as in Example 1, was applied. The material and crude were observed to harden and coagulate. Excess containment material able to react when coming in contact with hydrocarbons was observed as white. The coagulate does not foul nets. It does not stick to booms. After about four minutes, the coagulate was corralled with a light stream of water. At the side of the pool, the coagulate was skimmed off the water with the experimenter's hand and with a stiff sheet. The coagulate clumps under light hand pressure.

### Example 3

This Example serves to illustrate the oil containment action of the polymeric material for an oil spill on land.

In a typical procedure, motor oil was applied to a concrete surface. A quantity of a polymeric oil adsorbing material, ROK Solid X Factor, available from ROK Protective Systems, Inc., was applied to the oil spill so as to cover the spill. The material adsorbed the oil within minutes. A shovel was used to collected to collect the coagulate of oil and polymeric material and dispense it into a convention receptacle for picking up trash.

In conclusion, the present invention provides materials, system, and method for oil containment.

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. An oil spill containment system, comprising:
a plurality of granules of a bacterial nutrient material; and
a plurality of particles of a polymeric material active for adsorbing oil.

2. The oil spill containment system according to claim 1, wherein the polymeric material comprises a synthetic polymer.

3. The oil spill containment system according to claim 2, wherein the synthetic polymer is selected from the group consisting of polypropylene, polyethylene, polyurethane, polyester, and combinations thereof.

4. The oil spill containment system according to claim 3, wherein the synthetic polymer comprises recycled polymer.

4. The oil spill containment system according to claim 1, wherein the polymeric material comprises a natural product.

5. The oil spill containment system according to claim 4, wherein the natural product is selected from the group consisting of palm oils and beeswax.

6. The oil spill containment system according to claim 4, wherein the natural product comprises coconut flakes.

7. The oil spill containment system according to claim 1, wherein the bacterial nutrient material comprises an inorganic compound selected from the group consisting of nitrates and phosphates.

8. The oil spill containment system according to claim 1, wherein the bacterial nutrient material comprises bee pollen.

9. An oil spill containment system, comprising:
a plurality of granules of a bacterial nutrient material; and
a plurality of particles of a polymeric material active for adsorbing oil, the polymeric material comprising a polymeric material comprising a synthetic polymer and natural product.

10. The oil spill containment system according to claim 9, wherein the synthetic polymer is selected from the group consisting of polypropylene, polyethylene, polyurethane, polyester, and combinations thereof.

11. The oil spill containment system according to claim 9, wherein the synthetic polymer comprises recycled polymer.

12. The oil spill containment system according to claim 9, wherein the natural product is selected from the group consisting of palm oils and beeswax.

13. The oil spill containment system according to claim 9, wherein the natural product comprises coconut flakes.

14. The oil spill containment system according to claim 9, wherein the synthetic polymer comprises recycled polymer and the natural product comprises coconut flakes.

15. The oil spill containment system according to claim 9, wherein the bacterial nutrient material comprises an inorganic compound selected from the group consisting of nitrates and phosphates.

16. The oil spill containment system according to claim 9, wherein the bacterial nutrient material comprises bee pollen.

17. A method for containing oil in an oil spill at a location, comprising:
mixing a plurality of particles of a polymeric material active for adsorbing oil with a plurality of granules of a bacterial nutrient material so as to form an oil spill containment system;
applying the oil spill containment system to the oil; and
removing the oil and the oil spill containment system from the location.

18. The method according to claim 17, further comprising allowing the oil to adsorb to the particles of the polymeric material before the removing.

19. The method according to claim 17, further comprising exposing the oil and the oil spill containment system to bacteria after the removing.

20. The method according to claim 19, wherein the exposing comprises allowing the bacteria to break down the oil, fed by the bacterial nutrient material.
